(19) United States
(12) Patent Application Publication
(10) Pub. No.: US 2024/0316997 A1
(43) Pub. Date: Sep. 26, 2024

(54) TIRE ASSEMBLY

(71) Applicant: Sumitomo Rubber Industries, Ltd., Kobe-shi (JP)

(72) Inventor: Hiroaki NINOMIYA, Kobe-shi (JP)

(73) Assignee: Sumitomo Rubber Industries, Ltd., Kobe-shi (JP)

(21) Appl. No.: 18/434,865

(22) Filed: Feb. 7, 2024

(30) Foreign Application Priority Data
Mar. 22, 2023 (JP) 2023-045745

(51) Int. Cl. B60C 19/00; B60C 5/00

(52) U.S. Cl. CPC B60C 19/002; B60C 5/002

(57) ABSTRACT

A tire assembly can include a rim and a pneumatic tire. A sound damper can be in a tire inner cavity, defined by an outer surface of the rim and an inner surface of the pneumatic tire, extending in a tire circumferential direction. The rim can have a rim diameter RD not greater than 18 inches. A ratio SH/SW of a cross-sectional height SH to a tire cross-sectional width SW of the pneumatic tire can be 30% to 45%. A ratio RW/SW of a rim width RW of the rim to the tire cross-sectional width SW can be 78% to 99%. The sound damper can include a sponge material adhered to at least one of the outer surface of the rim and the inner surface of the pneumatic tire. The sponge material can have a volume of not less than 0.4% of a total volume of the tire inner cavity.

### CROSS-REFERENCE TO RELATED APPLICATION(S)

The present application claims priority to Japanese patent application JP 2023-045745, filed on Mar. 22, 2023, the entire contents of which is incorporated herein by reference in its entirety.

### BACKGROUND

### Field

The present disclosure relates to a tire assembly including a rim and a pneumatic tire mounted on the rim.

### Background Art

Japanese Laid-Open Patent Publication No. 2006-306302 proposes an assembly which includes a pneumatic tire and a rim and in which a sound damper made of a specific sponge material is placed in a tire inner cavity to reduce road noise during running.

However, the assembly in Japanese Laid-Open Patent Publication No. 2006-306302 is described as intended to be used as a general tire for a passenger car, and is not intended as a high-load small-diameter tire used for a low-floor small bus and the like.

### SUMMARY

According to an aspect of the present disclosure, a tire assembly can include a rim and a pneumatic tire mounted on the rim, wherein a sound damper can be provided in a tire inner cavity, defined by an outer surface of the rim and an inner surface of the pneumatic tire, so as to extend in a tire circumferential direction, the rim can have a rim diameter RD of not greater than 18 inches, a ratio SH/SW of a cross-sectional height SH to a tire cross-sectional width SW of the pneumatic tire can be 30% to 45%, a ratio RW/SW of a rim width RW of the rim to the tire cross-sectional width SW can be 78% to 99%, the sound damper can include a sponge material adhered to at least one of the outer surface of the rim and the inner surface of the pneumatic tire, and the sponge material can have a volume of not less than 0.4% of a total volume of the tire inner cavity.

### BRIEF DESCRIPTION OF THE DRAWINGS

FIG. 1 is a cross-sectional view showing a tire assembly according to one or more embodiments of the present disclosure;

FIG. 2 is a cross-sectional view of a pneumatic tire outfitted with a tire assembly according to one or more embodiments of the present disclosure; and

FIG. 3 is an end view of the tire assembly according to one or more embodiments of the present disclosure at a tire equator thereof.

### DETAILED DESCRIPTION

Embodiments of present disclosure have been made in view of the above circumstances in the Background section, and an object of the present disclosure, according to one or more objects thereof, can be to provide a tire assembly that can reduce road noise even in the case of a high-load small-diameter tire.

By having a configuration according to one or more embodiments, the tire assembly can reduce road noise even in the case of a high-load small-diameter tire.

Hereinafter, an embodiment of the present disclosure will be described in detail with reference to the drawings.

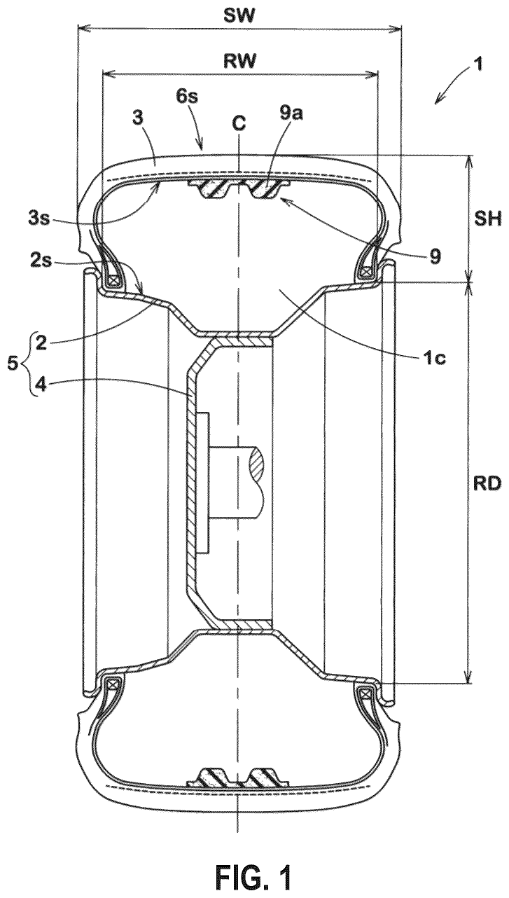

FIG. 1 is a tire meridian cross-sectional view showing a tire assembly 1 in a standardized state of the present embodiment. Here, the “standardized state” can be regarded as a state where a pneumatic tire 3 is mounted on a rim 2 and adjusted to a standardized internal pressure and no load is applied to the pneumatic tire 3. Hereinafter, unless otherwise specified, dimensions and the like of components of the tire assembly 1 are values measured in the standardized state.

If there is a standard system including a standard on which the pneumatic tire 3 is based, the “standardized internal pressure” can be regarded as an air pressure that is defined for each tire by the standard, and can be regarded as the “maximum air pressure” in the JATMA standard, the maximum value indicated in the table “TIRE LOAD LIMITS AT VARIOUS COLD INFLATION PRESSURES” in the TRA standard, or the “INFLATION PRESSURE” in the ETRTO standard, for instance. If there is no standard system including a standard on which the pneumatic tire 3 is based, the “standardized internal pressure” can be regarded as an air pressure that is defined for each tire by the manufacturer or the like.

As shown in FIG. 1, the tire assembly 1 can be suitably used as a high-load small-diameter tire such as a tire used for a low-floor small bus, for example. The tire assembly 1 of the present embodiment can be an assembly including the rim 2 and the pneumatic tire 3 mounted on the rim 2.

The rim 2, for example, can be combined with a disc 4 to form a wheel 5. That is, the wheel 5 can include the rim 2 and the disc 4. The rim 2 of one or more embodiments of the present disclosure can be welded to the disc 4. The rim 2 may, for example, be integrally formed with the disc 4. In addition, the rim 2 may, for example, be divided in the tire axial direction and sandwich the disc 4.

The rim 2 can have a rim diameter RD of not greater than 18 inches, according to one or more embodiments of the present disclosure. The tire assembly 1 may be intended for such a small-diameter tire. Such a tire assembly 1 can serve to reduce a tire outer diameter, and can improve the space efficiency in a vehicle space when mounted on a low-floor small bus, for example. From such a viewpoint, the rim diameter RD of the rim 2 can be more preferably not greater than 15 inches.

The rim diameter RD of the rim 2 can be preferably not less than 10 inches. Such a tire assembly 1 can ensure a space for placing a large-diameter brake, an in-wheel motor, etc., on the inner side in the tire radial direction of the rim 2. From such a viewpoint, the rim diameter RD of the rim 2 can be more preferably not less than 12 inches.

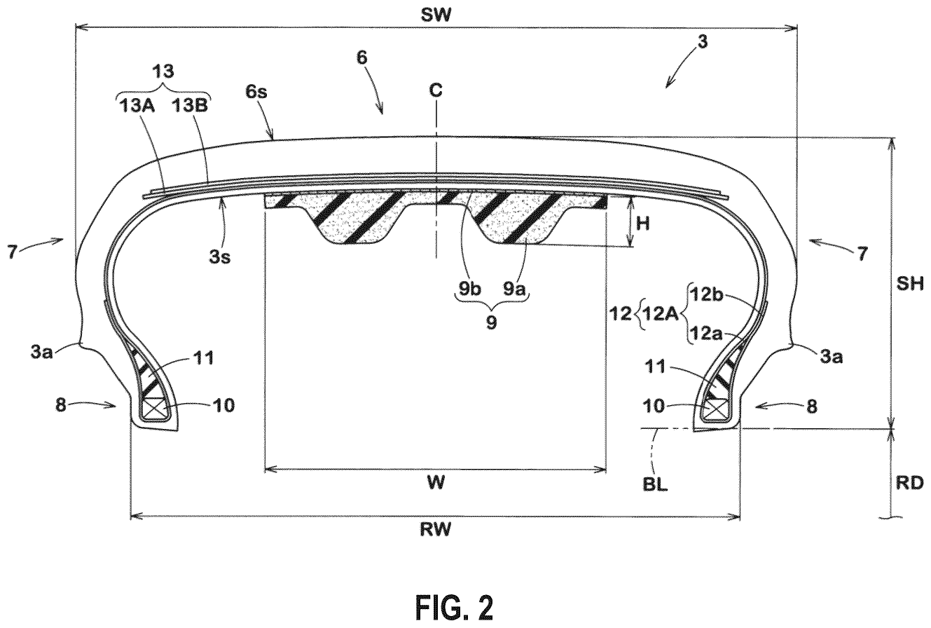

FIG. 2 is a tire meridian cross-sectional view of the pneumatic tire 3 in the standardized state, and the pneumatic tire 3 can include a tread portion 6, a pair of sidewall portions 7, and a pair of bead portions 8. The tread portion 6 can have a ground-contact surface 6s which comes into contact with a road surface during rolling.

The pair of sidewall portions 7 can extend inward in the tire radial direction from both sides in the tire axial direction of the tread portion 6, respectively. The pair of bead portions 8 can be located inward of the sidewall portions 7 in the tire radial direction, respectively, and can come into contact with the rim 2 when mounted on the rim 2.

The ratio SH/SW of a cross-sectional height SH to a tire cross-sectional width SW of the pneumatic tire 3 can be 30% to 45%, as an example. Such a pneumatic tire 3 can increase the volume of a tire inner cavity 1c while reducing the tire outer diameter, and can be suitably used, for example, as a high-load small-diameter tire required for a low-floor small bus.

Here, the tire cross-sectional width SW can be regarded as the width in the tire axial direction at a maximum width position of the sidewall portions 7, not including protruding portions, such as letters and patterns, and a rim guard 3a. In addition, the cross-sectional height SH can be regarded as the height in the tire radial direction from a bead base line BL for defining the rim diameter RD to the ground-contact surface 6s at a tire equator C. Moreover, the tire inner cavity 1c can be a space defined by an outer surface 2s of the rim 2 and an inner surface 3s of the pneumatic tire 3.

The ratio RW/SW of a rim width RW of the rim 2 to the tire cross-sectional width SW can be preferably 78% to 99%. Such a rim 2 can serve to increase the volume of the tire inner cavity 1c since the rim width RW can be regarded as large relative to the tire cross-sectional width SW.

A sound damper 9 can be provided in the tire inner cavity 1c so as to extend in the tire circumferential direction. The sound damper 9 can include a sponge material 9a adhered to at least one of the outer surface 2s of the rim 2 and the inner surface 3s of the pneumatic tire 3, according to one or more embodiments of the present disclosure, to the inner surface 3s of the pneumatic tire 3. Such a sound damper 9 can suppress cavity resonance sound generated in the tire inner cavity 1c and reduce the road noise of the tire assembly 1.

The sponge material 9a can have a volume of not less than 0.4% of the total volume of the tire inner cavity 1c. Such a sponge material 9a can reliably achieve the effect of reducing road noise by the sound damper 9. Therefore, the tire assembly 1 can reduce road noise even in the case of a high-load small-diameter tire.

Here, the volume of the sponge material 9a can be a volume obtained from the outer shape of the sponge material 9a including the space inside the sponge material 9a, and can be a value measured in a state where the pneumatic tire 3 is removed from the rim 2. In addition, the total volume of the tire inner cavity 1c can correspond to the volume in the standardized state of the tire inner cavity 1c in a state where the sponge material 9a is not provided therein.

According to one or more embodiments, the volume of the sponge material 9a can be not greater than 20% of the total volume of the tire inner cavity 1c. Such a sponge material 9a can both reduce both the cost of the tire assembly 1 and the road noise of the tire assembly 1.

As shown in FIG. 2, the sponge material 9a can be preferably placed at a center position in the tire axial direction of the tire inner cavity 1c, including a position on the tire equator C. Such a sponge material 9a can efficiently suppress cavity resonance sound generated near the tire equator C at which vibration due to input from a road surface is the largest.

The ratio W/SW of a width W in the tire axial direction of the sponge material 9a to the tire cross-sectional width SW can be preferably 10% to 70%. When the ratio W/SW is not less than 10%, the effect of reducing road noise by the sound damper 9 can be reliably achieved. When the ratio W/SW is not greater than 70%, both reduction of the cost of the tire assembly 1 and reduction of the road noise of the tire assembly 1 can be achieved.

Since the sponge material 9a can be placed at the center position in the tire axial direction of the tire inner cavity 1c, road noise can be efficiently reduced even if the width W is small. From such a viewpoint, the ratio W/SW can be more preferably not greater than 50% and further preferably not greater than 30%. Here, the width W of the sponge material 9a can be a value measured in a state where the pneumatic tire 3 is removed from the rim 2.

The sponge material 9a can have a maximum height H in the tire radial direction of not greater than 30 mm. Such a sponge material 9a can suppress peeling during high speed running, and can improve the durability of the tire assembly 1. From such a viewpoint, the maximum height H of the sponge material 9a can be more preferably not greater than 25 mm and further preferably not greater than 20 mm.

The lower limit of the maximum height H of the sponge material 9a may not be particularly limited, but can be preferably not less than 10 mm in order to reliably achieve the effect of reducing road noise by the sound damper 9. Here, the maximum height H of the sponge material 9a can be a value measured in a state where the pneumatic tire 3 is removed from the rim 2.

The sponge material 9a can have a hardness of 10 to 250 N. When the hardness of the sponge material 9a is not less than 10 N, cavity resonance sound can be efficiently suppressed. When the hardness of the sponge material 9a is not greater than 250 N, even if the sponge material 9a is adhered to the inner surface 3s of the pneumatic tire 3, the sponge material 9a can follow deformation caused by contact of the ground-contact surface 6s with the ground and suppress peeling. Here, the hardness of the sponge material 9a can be a value measured according to the method A specified in JIS K6400-2.

The sponge material 9a can have a tensile strength of not less than 70 kPa. When the tensile strength of the sponge material 9a is not less than 70 kPa, even if the sponge material 9a is adhered to the inner surface 3s of the pneumatic tire 3 and becomes deformed due to contact of the ground-contact surface 6s with the ground, the sponge material 9a is not damaged, and the durability of the sponge material 9a can be improved. Here, the tensile strength of the sponge material 9a can be a value measured according to the standards of JIS K6400-5.

The sponge material 9a preferably has a specific gravity of 0.014 to 0.052. When the specific gravity of the sponge material 9a is not less than 0.014, cavity resonance sound can be efficiently suppressed. When the specific gravity of the sponge material 9a is not greater than 0.052, weight increase can be suppressed. Here, the specific gravity of the sponge material 9a can be a value converted from an apparent density measured according to JIS K7222.

The sound damper 9 can include, for example, an adhesive layer 9b for adhering the sponge material 9a to the outer surface 2s of the rim 2 or the inner surface 3s of the pneumatic tire 3. Such a sound damper 9 can be firmly adhered to the outer surface 2s of the rim 2 or the inner surface 3s of the pneumatic tire 3, which can improve the durability of the sound damper 9.

A cross-sectional shape of the sponge material 9a can be a shape having two protruding portions in FIG. 2, but is not limited to such a shape, and may be, for example, a rectangular shape, or may be a semicircular shape, a trapezoidal shape, a triangular shape, or the like.

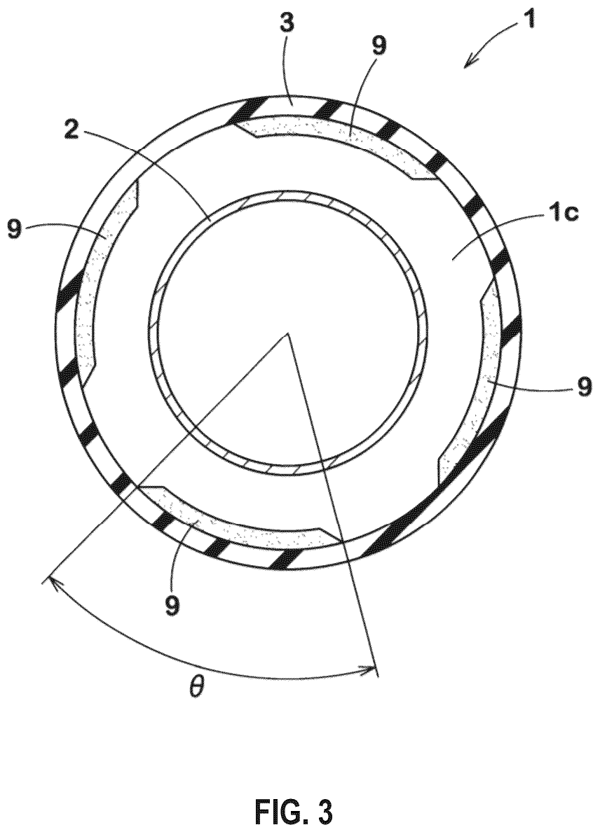

FIG. 3 is an end view of the tire assembly 1 at the tire equator C. As shown in FIG. 3, the sponge material 9a can be partially provided in the tire circumferential direction. Such a sponge material 9a can suppress weight increase and reduce the cost.

A total sum 20 of angles θ in the tire circumferential direction over which the sponge material 9a is provided can be preferably 108 to 270°. When the total sum 20 is not less than 108º, cavity resonance sound can be reliably suppressed. When the total sum 20 is not greater than 270°, weight increase can be suppressed and the cost can be reduced.

As shown in FIG. 2, each bead portion 8 can include, for example, an annular bead core 10 extending in the tire circumferential direction, and a bead apex 11 extending outward in the tire radial direction from the bead core 10. The bead core 10 can be formed, for example, from a steel wire. The bead apex 11 can be formed, for example, from a hard rubber. Such a bead portion 8 can have high stiffness, which can serve to suppress deformation in a load-applied state and reduce the road noise of the tire assembly 1.

The pneumatic tire 3 can include a carcass 12 extending between the pair of bead portions 8, and a belt layer 13 provided in the tread portion 6. The belt layer 13 can be provided, for example, outward of the carcass 12 in the tire radial direction.

The carcass 12 can include at least one carcass ply, according to one or more embodiments of the present disclosure, one carcass ply 12A (e.g., only the one carcass ply 12A). The carcass ply 12A can include a body portion 12a extending from the tread portion 6 through the sidewall portions 7 to the bead cores 10 of the bead portions 8, and turned-up portions 12b connected to the body portion 12a and turned up around the bead cores 10 from the inner side to the outer side in the tire axial direction. Such a carcass 12 can serve to improve the stiffness of each bead portion 8 and reduce the road noise of the tire assembly 1.

The carcass ply 12A can include, for example, carcass cords each composed of an organic fiber cord. Examples of the organic fiber cord can include a cord of a hybrid fiber of two or more fibers or one fiber selected from the group consisting of polyethylene terephthalate fibers, polyethylene naphthalate fibers, nylon fibers, aramid fibers, and rayon fibers.

The belt layer 13 can include at least one belt ply, preferably can include two or more belt plies, and can include two belt plies 13A and 13B of FIG. 2. The two belt plies 13A and 13B can include, for example, a first belt ply 13A located on the inner side in the tire radial direction and a second belt ply 13B located outward of the first belt ply 13A. Such a belt layer 13 can improve the stiffness of the tread portion 6 and can reduce the road noise of the tire assembly 1.

The belt plies 13A and 13B each include, for example, a belt cord composed of a steel cord. The belt cord may be, for example, a single steel wire or a twisted wire obtained by twisting a plurality of steel filaments together.

The belt cord can be arranged, for example, at an angle of 10 to 30° with respect to the tire circumferential direction. The belt cord of the first belt ply 13A and the belt cord of the second belt ply 13B can be preferably tilted relative to the tire circumferential direction in directions opposite to each other.

Such a belt layer 13 can increase the stiffness of the tread portion 6 in a well-balanced manner and reduce the road noise of the tire assembly 1. Here, the angle of each belt cord can be an angle in the pneumatic tire 3 in the standardized state, and can be confirmed, for example, by partially peeling off the tread portion 6.

Although the particularly preferred embodiments of the present disclosure have been described in detail above, embodiments of the present disclosure are not limited to the above-described embodiment, and various modifications can be made to implement.

### Additional Note

One or more embodiments of the present disclosure can be as follows.

### Present Disclosure 1

A tire assembly including a rim and a pneumatic tire mounted on the rim, wherein
a sound damper is provided in a tire inner cavity, defined by an outer surface of the rim and an inner surface of the pneumatic tire, so as to extend in a tire circumferential direction,
the rim has a rim diameter RD of not greater than 18 inches,
a ratio SH/SW of a cross-sectional height SH to a tire cross-sectional width SW of the pneumatic tire is 30% to 45%,
a ratio RW/SW of a rim width RW of the rim to the tire cross-sectional width SW is 78% to 99%,
the sound damper includes a sponge material adhered to at least one of the outer surface of the rim and the inner surface of the pneumatic tire, and
the sponge material has a volume of not less than 0.4% of a total volume of the tire inner cavity.

### Present Disclosure 2

The tire assembly according to Present Disclosure 1, wherein the rim diameter RD is not less than 10 inches.

### Present Disclosure 3

The tire assembly according to Present Disclosure 1 or 2, wherein the volume of the sponge material is not greater than 20% of the total volume of the tire inner cavity.

### Present Disclosure 4

The tire assembly according to any one of Present Disclosures 1 to 3, wherein
the sponge material is partially provided in the tire circumferential direction, and
a total sum of angles in the tire circumferential direction over which the sponge material is provided is 108 to 270°.

### Present Disclosure 5

The tire assembly according to any one of Present Disclosures 1 to 4, wherein a ratio W/SW of a width W in a tire axial direction of the sponge material to the tire cross-sectional width SW is 10% to 70%.

### Present Disclosure 6

The tire assembly according to any one of Present Disclosures 1 to 5, wherein the sponge material has a maximum height in a tire radial direction of not greater than 30 mm.

### Present Disclosure 7

The tire assembly according to any one of Present Disclosures 1 to 6, wherein the sponge material has a hardness of 10 to 250 N.

### Present Disclosure 8

The tire assembly according to any one of Present Disclosures 1 to 7, wherein the sponge material has a tensile strength of not less than 70 kPa.

### Present Disclosure 9

The tire assembly according to any one of Present Disclosures 1 to 8, wherein the sponge material has a specific gravity of 0.014 to 0.052.

### Present Disclosure 10

The tire assembly according to any one of Present Disclosures 1 to 9, used for a low-floor small bus.

### Present Disclosure 11

A pneumatic tire mountable on a rim having a rim diameter RD of not greater than 18 inches, the pneumatic tire comprising: a sound damper on an inner surface of the pneumatic tire, the sound damper extending in a tire circumferential direction, a ratio SH/SW of a cross-sectional height SH to a tire cross-sectional width SW of the pneumatic tire is 30% to 45%, the sound damper includes a sponge material adhered to the inner surface of the pneumatic tire, a ratio W/SW of a width W in a tire axial direction of the sponge material to the tire cross-sectional width SW is 10% to 70%, the sponge material has a maximum height H in the tire radial direction of not less than 10 mm and not greater than 30 mm, the sound damper is centered at center position in the tire axial direction of the inner surface of the pneumatic tire, including at a position on a tire equator C, the sponge material has a hardness of 10 to 250 N, the sponge material has a tensile strength of not less than 70 kPa, and the sponge material has a specific gravity of 0.014 to 0.052.

### Present Disclosure 12

The pneumatic tire according to Present Disclosure 11, wherein the sponge material of the sound damper is adhered to both an outer surface of the rim and the inner surface of the pneumatic tire.

### Present Disclosure 13

The pneumatic tire according to Present Disclosure 11 or Present Disclosure 12, wherein the sponge material has a volume of not less than 0.4% and not greater than 20% of a total volume of a tire inner cavity formed by an outer surface of the rim and the inner surface of the pneumatic tire, and a ratio RW/SW of a rim width RW of the rim to the tire cross-sectional width SW is 78% to 99%.

### Present Disclosure 14

The pneumatic tire according to any one of Present Disclosure 11 to Present Disclosure 13, wherein the ratio W/SW is not greater than 30%, and the maximum height H of the sponge material is not greater than 20 mm in the tire radial direction.

### Present Disclosure 15

The pneumatic tire according to any one of Present Disclosure 11 to Present Disclosure 14, wherein the sound damper includes an adhesive layer to adhere the sponge material to the inner surface of the pneumatic tire.

### Present Disclosure 16

The pneumatic tire according to any one of Present Disclosure 11 to Present Disclosure 15, wherein the sponge material has a shape with two protruding portions in a cross-sectional view of the pneumatic tire.

### Present Disclosure 17

The pneumatic tire according to any one of present Disclosure 11 to Present Disclosure 16, wherein the two protruding portions are spaced from opposite ends of the sponge material in the tire axial direction.

### Present Disclosure 18

The pneumatic tire according to any one of Present Disclosure 11 to Present Disclosure 17, wherein the sponge material consists of a plurality of distinct sponge material portions partially provided on the inner surface of the pneumatic tire in the tire circumferential direction, and a total sum of angles in the tire circumferential direction over which the sponge material is provided is 108 to 270°.

What is claimed is:

1. A tire assembly comprising:
a rim; and
a pneumatic tire mounted on the rim, wherein
a sound damper in a tire inner cavity, defined by an outer surface of the rim and an inner surface of the pneumatic tire, and that extends in a tire circumferential direction,
the rim has a rim diameter RD of not greater than 18 inches,
a ratio SH/SW of a cross-sectional height SH to a tire cross-sectional width SW of the pneumatic tire is 30% to 45%,
a ratio RW/SW of a rim width RW of the rim to the tire cross-sectional width SW is 78% to 99%,
the sound damper includes a sponge material adhered to at least one of the outer surface of the rim and the inner surface of the pneumatic tire, and
the sponge material has a volume of not less than 0.4% of a total volume of the tire inner cavity.

2. The tire assembly according to claim 1, wherein the rim diameter RD is not less than 10 inches.

3. The tire assembly according to claim 1, wherein the volume of the sponge material is not greater than 20% of the total volume of the tire inner cavity.

4. The tire assembly according to claim 1, wherein
the sponge material is partially provided in the tire circumferential direction, and
a total sum of angles in the tire circumferential direction over which the sponge material is provided is 108 to 270°.

5. The tire assembly according to claim 1, wherein a ratio W/SW of a width W in a tire axial direction of the sponge material to the tire cross-sectional width SW is 10% to 70%.

6. The tire assembly according to claim 1, wherein the sponge material has a maximum height in a tire radial direction of not greater than 30 mm.

7. The tire assembly according to claim 1, wherein the sponge material has a hardness of 10 to 250 N.

8. The tire assembly according to claim 1, wherein the sponge material has a tensile strength of not less than 70 kPa.

9. The tire assembly according to claim 1, wherein the sponge material has a specific gravity of 0.014 to 0.052.

10. The tire assembly according to claim 1, wherein the tire assembly is used for a low-floor small bus.

11. A pneumatic tire mountable on a rim having a rim diameter RD of not greater than 18 inches, the pneumatic tire comprising:
a sound damper on an inner surface of the pneumatic tire, the sound damper extending in a tire circumferential direction,
a ratio SH/SW of a cross-sectional height SH to a tire cross-sectional width SW of the pneumatic tire is 30% to 45%,
the sound damper includes a sponge material adhered to the inner surface of the pneumatic tire,
a ratio W/SW of a width W in a tire axial direction of the sponge material to the tire cross-sectional width SW is 10% to 70%,
the sponge material has a maximum height H in the tire radial direction of not less than 10 mm and not greater than 30 mm,
the sound damper is centered at center position in the tire axial direction of the inner surface of the pneumatic tire, including at a position on a tire equator C,
the sponge material has a hardness of 10 to 250 N,
the sponge material has a tensile strength of not less than 70 kPa, and
the sponge material has a specific gravity of 0.014 to 0.052.

12. The pneumatic tire according to claim 11, wherein the sponge material of the sound damper is adhered to both an outer surface of the rim and the inner surface of the pneumatic tire.

13. The pneumatic tire according to claim 11, wherein
the sponge material has a volume of not less than 0.4% and not greater than 20% of a total volume of a tire inner cavity formed by an outer surface of the rim and the inner surface of the pneumatic tire, and
a ratio RW/SW of a rim width RW of the rim to the tire cross-sectional width SW is 78% to 99%.

14. The pneumatic tire according to claim 11, wherein
the ratio W/SW is not greater than 30%, and
the maximum height H of the sponge material is not greater than 20 mm in the tire radial direction.

15. The pneumatic tire according to claim 11, wherein the sound damper includes an adhesive layer to adhere the sponge material to the inner surface of the pneumatic tire.

16. The pneumatic tire according to claim 11, wherein the sponge material has a shape with two protruding portions in a cross-sectional view of the pneumatic tire.

17. The pneumatic tire according to claim 16, wherein the two protruding portions are spaced from opposite ends of the sponge material in the tire axial direction.

18. The pneumatic tire according to claim 11, wherein
the sponge material consists of a plurality of distinct sponge material portions partially provided on the inner surface of the pneumatic tire in the tire circumferential direction, and
a total sum of angles in the tire circumferential direction over which the sponge material is provided is 108 to 270°.
